(19) United States
(12) Patent Application Publication
(10) Pub. No.: US 2024/0396004 A1
(43) Pub. Date: Nov. 28, 2024

(54) PRE-LITHIATION OF LITHIUM-ION BATTERY ANODES

(71) Applicant: Albemarle Corporation, Charlotte, NC (US)

(72) Inventors: Mark J. Hintze, Charlotte, NC (US); Y. M. Chen, Charlotte, NC (US); Xiaoguang Hao, Charlotte, NC (US); Yikai Wang, Charlotte, NC (US)

(73) Assignee: Albemarle Corporation, Charlotte, NC (US)

(21) Appl. No.: 18/693,710

(22) PCT Filed: Sep. 20, 2022
(86) PCT No.: PCT/US2022/044096

§ 371 Date: Mar. 20, 2024

Related U.S. Application Data
(60) Provisional application No. 63/246,937, filed on Sep. 22, 2021.

(51) Int. Cl. H01M 4/04; H01M 4/02; H01M 4/133; H01M 4/134; H01M 4/1393; H01M 4/1395

(52) U.S. Cl. CPC H01M 4/0459; H01M 4/0435; H01M 4/133; H01M 4/134; H01M 4/1393; H01M 4/1395; H01M 2004/028

(57) ABSTRACT

This invention provides processes for prelithiating anode materials for lithium-ion batteries.

### TECHNICAL FIELD

This invention relates to new processes for prelithiating anode materials for lithium-ion batteries.

### BACKGROUND

Lithium-ion batteries are used in a variety of consumer electronics and are increasingly being adopted for use in electric vehicles. Researchers and developers are focused on improving the performance of lithium ion batteries for such applications. A problem with some anode materials is lithium loss during battery cycling, especially the first charge/discharge cycle, in which lithium losses are typically irreversible, and sometimes the lithium loss is relatively large. Graphite, silicon materials, and blends of graphite and silicon materials are often used as anode materials in lithium-ion batteries.

The irreversible first-cycle lithium loss may be caused by the consumption of lithium ions in the formation of a solid electrolyte interphase layer (SEI). To minimize lithium loss through this route, the anode is often pre-lithiated; several techniques have been developed. Prelithiated anodes can be formed by intercalation or alloying reactions of lithium ions with carbon- or silicon-based anode materials. Another prelithiation method, referred to as the “direct contact” or the “internal short circuit” method, comprises bringing lithium metal into direct contact with an anode in the presence of the electrolyte solution, which releases electrons to ionize the lithium metal; lithium foils or lithium powders are often used as the lithium metal source.

In the direct contact prelithiation method, both lithium foils and lithium metal powders have drawbacks as lithium sources. Lithium foils that are thin (20 μm or less) can cover an anode surface uniformly, but are fragile and expensive. Thick lithium foil (50 μm or more) needs to be cut into strips to prevent overloading the anode, but this does not permit uniform coverage of the anode surface. Lithium metal powders can cover the anode surface uniformly, but the increased pressure needed to crack the passivation layer of the lithium metal powder can damage the anode, and the high surface area of lithium metal powders can increase the reaction rate with the electrolyte and thereby increase the temperature of the electrochemical cell.

Therefore, there is a need for new and improved methods for prelithiation of anodes for lithium-ion batteries that minimize or eliminate irreversible losses of lithium during the first charge/discharge cycle.

### SUMMARY OF THE INVENTION

This invention provides processes for prelithiation of anode material. An advantage of the processes described herein is that they permit control of the lithium loading on the anode material. Another advantage provided by the present invention is that thick lithium foils (50 μm or more) can be employed without experiencing the drawbacks that usually occur with such foils.

An embodiment of this invention is a process for prelithiating an anode material. The process comprises contacting, in an electrochemical cell, an anode material and a substrate surface of a substrate material, the substrate surface containing patterned lithium, to form a prelithiated anode material.

Another embodiment of this invention is a process for preparing a substrate surface containing patterned lithium. The process comprises
forming a layered sheet from a protective material, lithium-containing foil, and a substrate material, wherein the protective material is in contact with one side of the lithium-containing foil, and a substrate surface of the substrate material is in contact with the other side of the lithium-containing foil,
placing the layered sheet in a patterning device, subjecting the layered sheet to patterning by the patterning device, and removing the layered sheet from the patterning device; and
removing the protective material and lithium-containing foil from the substrate surface of the substrate material, to obtain the substrate material comprising the substrate surface containing patterned lithium.

Other embodiments of the invention include a process for prelithiating an anode material, which process comprises preparing a substrate material comprising a substrate surface containing patterned lithium, and contacting, in an electrochemical cell, an anode material and the substrate surface of the substrate material, the substrate surface containing patterned lithium, to form a prelithiated anode material.

These and other embodiments and features of this invention will be still further apparent from the ensuing description, drawings, and appended claims.

### BRIEF DESCRIPTION OF THE DRAWINGS

FIG. 1 is a graphical representation of the protective layer, lithium-containing foil, substrate material, and the layered sheet formed therefrom.

FIG. 2 shows two false-shading micrographs from a confocal microscope showing the different heights of Li on copper foil from two different patterning pressures with the same die.

FIG. 3A is a photograph of copper foil substrate that has patterned lithium thereon; FIG. 3B is a photograph of the same copper foil substrate after prelithiation of an anode material.

The figures illustrate embodiments of specific aspects of the invention, and are not intended to impose limitations on the scope of the invention.

### FURTHER DETAILED DESCRIPTION OF THE INVENTION

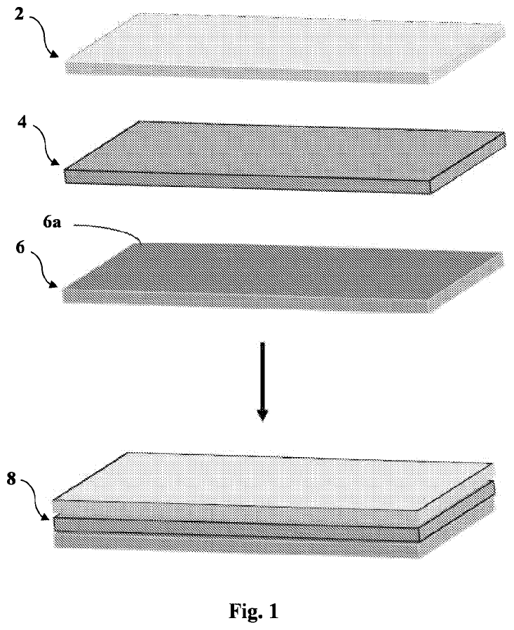

To prepare a substrate material comprising a substrate surface containing patterned lithium, the first step is generally formation of a layered sheet from a protective material, lithium-containing foil, and a substrate material. In the layered sheet, the protective material is in contact with one side of the lithium-containing foil, and the substrate material is in contact with the other side of the lithium-containing foil. In the layered sheet, the lithium-containing foil is the middle layer between the protective material and the substrate material. This is illustrated in FIG. 1, which shows the protective layer 2, lithium-containing foil 4, substrate material 6, and the layered sheet 8 formed therefrom. Substrate material 6 has a substrate surface 6a, which will contact the lithium-containing foil 4, to form the substrate surface containing patterned lithium of the substrate material.

The purpose of the protective material is to prevent the lithium-containing foil from adhering to the surfaces of the patterning device, and the protective material can be any convenient material, that does not tear under patterning conditions. Typically, the protective material is a plastic film, such as a polyethylene film or a polypropylene film.

Suitable lithium-containing foils include lithium metal foil, and lithium alloy foils, including LiMg foil, LiAl foil, LiAg foil, LiSn foil, and LiZn foil. Lithium metal foil is often preferred.

Lithium-containing foils have a thickness typically ranging from about 30 μm to about 200 μm, more often about 40 μm to about 150 μm. This parameter has not been optimized, although it is recognized that thicker foils transfer larger amounts of lithium under the same patterning conditions.

The substrate material can be any convenient material, including metal foils, and plastic films such as polyethylene film or polypropylene film. Metal foils are a preferred substrate material, and are generally selected from metals such as nickel or copper. Preferred metal foils include copper foil and nickel foil; copper foil is more preferred.

It is recommended and preferred to handle lithium-containing foils in the absence of water (e.g., a humidity of about 1.5% or less). This can be accomplished with a vacuum, or an inert atmosphere, such as helium, nitrogen, or argon. An inert atmosphere is preferred. Adventitious amounts of water may be present. Once the layered sheet has been formed, the exclusion of moisture is not necessary because the lithium-containing foil is essentially encased between the protective material layer and the substrate material layer.

The layered sheet is placed in a patterning device and subjected to the patterning procedure of the device. Patterning devices include die presses, automatic stamping machines, and roll presses, in which the pattern is transferred from the roller into the layered sheet.

A variety of patterns can be stamped to transfer the lithium to the substrate material. Examples of patterns that can be used include dot matrices and parallel lines. The density of some patterns can vary. For example, in a dot matrix pattern, the number of dots per unit area can be changed; for the parallel lines, the line width and/or the separation between the lines of the pattern can be different. These changes in patterns usually require using a different patterning element (die or roller) for each pattern variation. Changing the pattern is one way to change the amount of lithium transferred from the lithium-containing foil to the substrate material.

When using a die and press, the type of press used to apply pressure to the die is not believed to be of particular significance. A floor press can be used. When the patterning device is a die in a floor press, the layered sheet is placed in the die and stamped by applying pressure, usually about 1000 psi to about 3000 psi (about 6.89 MPa to about 20.7 MPa); preferably the pressure is about 1500 psi to about 2500 psi (about 10.3 MPa to about 17.2 MPa). This parameter has not been optimized.

The process forms a shaped layered sheet, which is removed from the patterning device. The patterning process transfers lithium (and the other metal(s), if an alloy was used) from the foil onto the substrate surface, in the pattern from the patterning device.

Throughout this document, transfer of lithium (and other metals, if an alloy) is onto a surface of a substrate material; however, it is to be understood that some of the metal atoms transferred may be below the surface of the substrate material, although results to date indicate that most of the metal(s) transferred remain on the surface of the substrate material. The extent of subsurface penetration, if any, by the transferred metal atoms has not been determined.

Removal of the protective layer and lithium-containing foil yields the substrate material comprising the substrate surface containing patterned lithium. It may be possible to remove the substrate material from the lithium-containing foil and the protective material in one step, in which the protective material and the lithium-containing foil remain together; this is not recommended because it may result in removal of some of the transferred lithium from the substrate material. Preferably, the protective layer is removed from the lithium-containing foil, and then the lithium-containing foil is removed from the substrate. A factor to consider when selecting a pattern is the ease of removal of the lithium-containing foil from the patterned substrate material.

There are advantages provided by this patterning process. The amount of lithium transferred to a substrate material can be controlled by changing the thickness of the lithium foil and/or by changing the conditions used in the patterning device. The same patterning device can be used at different conditions such as different pressures without altering the composition of the layered sheets being fed to the device to transfer differing amounts of lithium to the substrate material. Another way to change the amount of lithium transferred to the substrate material is by feeding a layered sheet with a lithium-containing foil of a different thickness to the patterning device without changing the patterning conditions. Both the thickness of the lithium-containing foil and the patterning device conditions can be changed to give a wider range of lithium amounts transferred without needing to use a different patterning die, roller, or device.

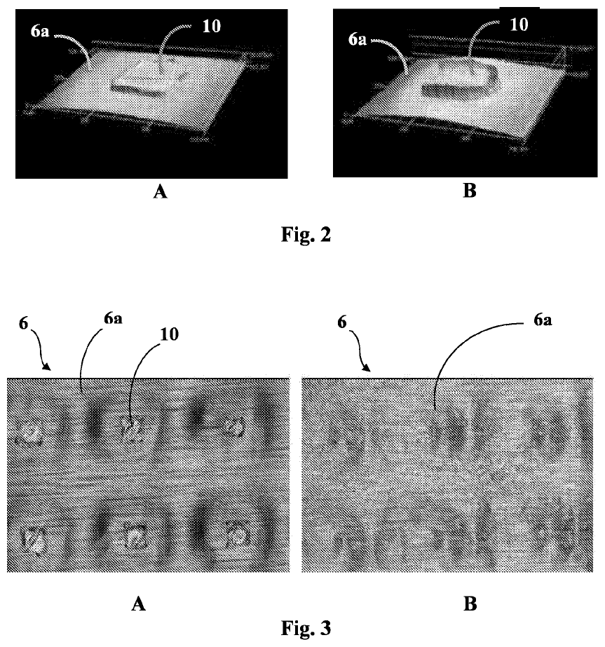

An illustration of the differing amounts of lithium that can be transferred is shown in FIG. 2, which has two false-shading micrographs from a confocal microscope showing different heights of lithium transferred onto copper foil (the substrate material). In FIG. 2, the lithium 10 on the substrate surface 6a of the substrate material in A has a height of about 10 μm; the lithium 10 on the substrate surface 6a of the substrate material in B has a height of about 35 μm. The different heights indicate different amounts of lithium transferred to the substrate surface of the substrate material.

Because the height of the transferred lithium pattern can be controlled, different amounts of lithium can be transferred to a substrate with the same patterning element in the same patterning device, eliminating the need to change patterning elements (e.g., dies or rollers) to transfer larger or smaller amounts of lithium. In some preferred embodiments, for example, a larger amount of lithium can be transferred by using the same die at a higher pressure. In other embodiments, a larger amount of lithium can be transferred at the same pressure by changing the die or roller to one that has a denser pattern, such as a dot matrix die which has more dots per unit area.

In the prelithiation process, an anode material and a substrate surface of the substrate material are contacted in an electrochemical cell, which substrate surface contains patterned lithium, to form a prelithiated anode material (and a substrate surface that is at least partially delithiated).

The anode material can be any anode material that can be used in the formation of lithium batteries, including graphite, one or more silicon materials, blends of graphite and one or more silicon materials, various metals and alloys, which alloys can be lithium alloys. Anode materials, especially for lithium batteries, are often graphite or blends of graphite and one or more silicon materials.

The substrate material comprising a surface containing patterned lithium can be prepared as described above. Substrate materials and preferences therefor are as described above.

The substrate surface containing patterned lithium (the patterned side of the substrate material) is brought into contact with the anode material to be prelithiated. The materials are placed in an electrochemical cell, usually after bringing them into contact. The materials in contact are allowed to remain in the electrochemical cell for a period of time sufficient to prelithiate the anode material. The prelithiation process at least partially delithiates substrate material's substrate surface containing patterned lithium. On the laboratory scale, the length of time needed to prelithiate the anode material was about 30 minutes to about 60 minutes.

The liquid medium for the electrochemical cell is comprised of one or more solvents that typically form the liquid medium for solutions used in lithium batteries, which solvents are polar and aprotic, stable to electrochemical cycling, and preferably have low viscosity. These solvents usually include noncyclic carbonic acid esters, cyclic carbonic acid esters, ethers, sulfur-containing compounds, and esters of boric acid.

The solvents that can form the liquid medium for the electrochemical cell in the practice of this invention include ethylene carbonate (1,3-dioxolan-2-one), dimethyl carbonate, ethyl methyl carbonate, diethyl carbonate, dioxolane, dimethoxy ethane (glyme), tetrahydrofuran, ethylene sulfite, 1,3-propylene glycol boric ester, bis(2,2,2-trifluoroethyl)ether, and mixtures of any two or more of the foregoing.

Preferred solvents include ethylene carbonate, ethyl methyl carbonate, and mixtures thereof. More preferred are mixtures of ethylene carbonate and ethyl methyl carbonate, especially at volume ratios of ethylene carbonate:ethyl methyl carbonate ratios of about 20:80 to about 40:60, more preferably about 25:75 to about 35:65.

Suitable lithium-containing salts in the practice of this invention include lithium perchlorate, lithium nitrate, lithium thiocyanate, lithium aluminate, lithium tetrachloroaluminate, lithium tetrafluoroaluminate, lithium tetraphenylborate, lithium tetrafluoroborate, lithium bis(oxolato)borate (LiBOB), lithium di(fluoro)(oxalato)borate, lithium hexafluorophosphate, lithium hexafluoroarsenate, lithium hexafluoroantimonate, lithium titanium oxide, lithium manganese oxide, lithium cobalt oxide (LiCoO₂), lithium nickel oxide (LiNiO₂), lithium alkyl carbonates in which the alkyl group has 1 to 6 carbon atoms, lithium methylsulfonate, lithium trifluoromethylsulfonate, lithium pentafluorocthylsulfonate, lithium pentafluorophenylsulfonate, lithium fluorosulfonate, lithium bis(trifluoromethylsulfonyl)imide, lithium bis(pentafluoroethylsulfonyl)imide, lithium (ethylsulfonyl)(trifluoromethylsulfonyl)imide, and mixtures of any two or more of the foregoing. Preferred lithium-containing salts include lithium hexafluorophosphate, lithium tetrafluoroborate, lithium di(fluoro)(oxolato)borate, and lithium bis(oxolato)borate.

Typical concentrations for the lithium-containing salt in the solution for the electrochemical cell are in the range of about 0.1 M to about 2.5 M, preferably about 0.5 M to about 2 M, more preferably about 0.75 M to about 1.75 M, and still more preferably about 0.95 M to about 1.5 M. When more than one lithium-containing salt forms the lithium-containing electrolyte, the concentration refers to the total concentration of all of the lithium-containing salts present in the electrolyte solution.

After the prelithiation step, the contacted materials are removed from the electrochemical cell, and the substrate material is separated from the prelithiated anode material.

FIG. 3A shows a patterned copper foil (the substrate material 6 comprising a substrate surface 6a containing patterned lithium), in which lithium as dots are visible as the lighter shaded areas 10, and in FIG. 3B, the same copper foil (substrate material 6 comprising a substrate surface 6a) is shown after a prelithiation step, in which lithium (lighter shaded areas) is not observed.

Another embodiment of this invention is a process for assembling a lithium battery having an anode characterized in that at least a portion of the anode is formed from prelithiated anode material made as described above.

Still another embodiment of this invention is a lithium battery having an anode characterized in that at least a portion of the anode is comprised of prelithiated anode material made as described above.

The initial Coulombic efficiency of a lithium-ion battery formed from a prelithiated anode material prepared according to this invention can be further enhanced by increasing the loading of lithium in the anode material by making changes to the patterning process as described above to increase the amount of lithium transferred to the substrate material.

The following examples are presented for purposes of illustration, and are not intended to impose limitations on the scope of this invention.

### Example 1

For the patterning of the substrate with lithium-containing foil, in all runs the protective layer was polyethylene or polypropylene film, the lithium metal foil had a thickness of approximately 127 μm, and the substrate was copper foil. Lithium metal foil was placed over the copper foil, and the polyethylene or polypropylene film was placed on top of the lithium metal foil to form a layered sheet. Preparation of the layered sheets was carried out in an atmosphere having a humidity of about 1%.

In the runs of this Example, one of the dot matrix dies had tips that were 0.20 mm in diameter, with a 0.69 mm spacing between the dots, and about 2.25 dots/cm². The other dot matrix die had tips that were 0.20 mm in diameter, with a 0.97 mm spacing between the dots and about 4.5 dots/cm². Each die (Danly die set, Anchor Danly, Ontario, Canada) was mounted on a 25-ton floor press. The layered sheets were placed in the die set oriented so that the die was above the protective layer and pressed into the lithium metal foil into the copper foil. Pressure was then applied; for the run using the die with 4.5 dots/cm², the pressure applied was 2000 psi (13.8 MPa).

After the pressure was released, the layered sheet was removed from the die, and the protective layer was peeled off of the lithium metal foil, and then the lithium metal foil was peeled off of the copper foil. Visual inspection of the copper foil shows that the pattern from the die has transferred to the copper foil (see FIG. 3A). Subjecting the copper foils to scanning electron microscopy allowed measurement of the height of the patterns on the copper foils, which is reported in Table 1.

TABLE 1

| Pattern and size | Height of Li pattern on substrate |
|---|---|
| Dot matrix, 4.5 dots/cm² | 10 μm |
| Dot matrix, 2.25 dots/cm² | 35 μm |

### Example 2

Prelithiation was carried out in coin cells. The anodes were 16 mm in diameter, and the lithium-patterned copper foils were slightly larger than 16 mm in diameter to ensure complete coverage of the surfaces of the anode material. The electrolyte was 1.2 M LiPF₆ in a ratio of ethylene carbonate:diethylene carbonate 30:70 (wt.); a volume of 200 μL was used. The coin cell case was clamped (pinched) to provide a small amount of pressure, and the cells were allowed to sit for 30 minutes or 60 minutes.

At the end of the 30 minute or 60 minute period, the cell was disassembled. The patterned copper foils from the coin cells were inspected; in all instances a visual inspection showed no lithium metal present. FIG. 3 shows one of the copper foils used in this Example patterned with lithium in a dot matrix pattern (A), and the same copper foil after the prelithiation step (B). The absence of lithium on the copper foil after the prelithiation step indicates that the lithium transferred to the anode material.

### Example 3

Some of the prelithiated anode materials from Example 2 were used in the formation of batteries to evaluate the amount of lithium transferred from the Li foil. The half cell batteries were formed from prelithiated graphite or a Li-patterned Cu foil, a polypropylene separator (Celgard, LLC) and brushed Li metal foil as the counterelectrode. For both half cell batteries, the electrolyte was 1.2 M LiPF₆ in a ratio of ethylene carbonate:diethylene carbonate=30:70 (wt.); a volume of 200 μL was used. A galvanostatic charge at a current of 15 μA was applied to each battery cell. The battery cell containing the Li-patterned Cu foil had a delithiation capacity of 0.3 mAh/cm², and the battery cell containing the prelithiated graphite had an opening circuit voltage drop from 3 V to 0.4 V, and a capacity of 10 mAh/g_{graphite}.

### Example 4

Full battery cells were formed from prelithiated graphite with lithium nickel cobalt manganese oxide (NCM 622) as the cathode at a negative:positive (N/P) ratio of 1.1 based on the anode material and ignoring the lithium present from the prelithiation step. The electrolyte was 1.2 M LiPF₆ in ethylene carbonate:diethylene carbonate: 30:70 (wt.). The batteries were subjected to one electrochemical cycle of CCCV charging. Results are summarized in Table 2. The increase in the initial Coulombic efficiency observed for the battery containing the prelithiated anode indicates that prelithiation compensates for the irreversible lithium loss usually observed in the first charge/discharge cycle.

TABLE 2

| Anode | Initial Coulombic efficiency |
|---|---|
| Graphite¹ | 84% |
| Prelithiated graphite | 90..4% |

¹Comparative run.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the processes of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the processes; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A process for prelithiating an anode material, which process comprises contacting, in an electrochemical cell, an anode material and a substrate surface of a substrate material, the substrate surface containing patterned lithium, to form a prelithiated anode material.

2. A process as in claim 1 wherein the anode material is graphite, one or more silicon materials, or a blend of graphite and one or more silicon materials.

3. A process as in claim 1 wherein the substrate surface containing patterned lithium was prepared by
forming a layered sheet from a protective material, lithium-containing foil, and a substrate material, wherein the protective material is in contact with one side of the lithium-containing foil, and a substrate surface of the substrate material is in contact with the other side of the lithium-containing foil,
placing the layered sheet in a patterning device, subjecting the layered sheet to patterning by the patterning device, forming a shaped layered sheet and removing the shaped layered sheet from the patterning device; and
removing the protective material and the lithium-containing foil from the substrate surface of the substrate material, to obtain a substrate material comprising the substrate surface containing patterned lithium.

4. A process as in claim 3 wherein the lithium-containing foil is lithium metal foil

5. A process as in claim 3 wherein the lithium-containing foil has a thickness of about 30 μm to about 200 μm.

6. A process as in claim 3 wherein the forming of the layered sheet is conducted under vacuum or in an inert atmosphere.

7. A process as in claim 3 wherein the patterning device provides a dot matrix pattern.

8. A process as in claim 3 wherein the protective material is a plastic film.

9. A process as in claim 8 wherein the plastic film is a polyethylene film or a polypropylene film.

10. A process as in claim 1 wherein the substrate material is a metal foil.

11. A process as in claim 1 wherein the substrate material is a copper foil.

12. A process for prelithiating an anode material, which process comprises
forming a layered sheet from a protective material, lithium-containing foil, and a substrate material, wherein the protective material is in contact with one side of the lithium-containing foil, and a substrate surface of the substrate material is in contact with the other side of the lithium-containing foil;
placing the layered sheet in a patterning device, subjecting the layered sheet to patterning by the patterning device, and removing the layered sheet from the patterning device;
removing the protective material and the lithium-containing foil from the substrate surface of the substrate material, to obtain the substrate material comprising a substrate surface containing patterned lithium; and
contacting, in an electrochemical cell, an anode material and the substrate surface of a substrate material, the substrate surface containing patterned lithium, to form a prelithiated anode material.

13. A process as in claim 12 wherein the lithium-containing foil is lithium metal foil.

14. A process as in claim 12 wherein the lithium-containing foil has a thickness of about 30 μm to about 200 μm.

15. A process as in claim 12 wherein the forming of the layered sheet is conducted under vacuum or in an inert atmosphere.

16. A process as in claim 12 wherein the patterning device provides a dot matrix pattern.

17. A process as in claim 12 wherein the protective material is a plastic film.

18. A process as in claim 17 wherein the plastic film is a polyethylene film or a polypropylene film.

19. A process as in claim 13 wherein the anode material is graphite, one or more silicon materials, or a blend of graphite and one or more silicon materials.

20. A process as in claim 1 wherein the substrate material is a metal foil.

21. A process as in claim 1 wherein the substrate material is a copper foil.

22. A process for assembling a lithium battery having an anode characterized in that at least a portion of the anode is formed from a prelithiated anode material formed as in claim 1.

23. A lithium battery having an anode characterized in that at least a portion of the anode is comprised of a prelithiated anode material formed as in claim 1.
